(19) United States
(12) Patent Application Publication
(10) Pub. No.: US 2016/0165135 A1
(43) Pub. Date: Jun. 9, 2016

(54) IMAGE PHOTOGRAPHING APPARATUS, METHOD OF PHOTOGRAPHING IMAGE AND NON-TRANSITORY RECORDABLE MEDIUM

(71) Applicants: Yong-Hee LEE, Seoul (KR); Jin-Won LEE, Seongnam-si (KR)

(72) Inventors: Yong-Hee LEE, Seoul (KR); Jin-Won LEE, Seongnam-si (KR)

(73) Assignee: SAMSUNG ELECTRONICS CO., LTD, Suwon-si (KR)

(21) Appl. No.: 14/561,882

(22) Filed: Dec. 5, 2014

(51) Int. Cl. H04N 5/232; G06T 3/40; H04N 5/262

(52) U.S. Cl. CPC H04N 5/23238; H04N 5/2628; G06T 3/4038

(57) ABSTRACT

A imaging apparatus is disclosed. The imaging apparatus according to an exemplary embodiment includes a camera configured to capture a subject, a combiner configured to be combined with another imaging apparatus, a controller configured to perform capturing by controlling the camera and the other imaging apparatus, respectively, and an image processor configured to in response to a field of view interference occurring between the camera and the other imaging apparatus, delete an area where the field of view interference occurs from an image captured by the camera.

### CROSS-REFERENCE TO RELATED APPLICATION(S)

This application claims priority from Korean Patent Application No. 10-2014-0072275, filed on Jun. 13, 2014, in the Korean Intellectual Property Office, the disclosure of which is incorporated herein by reference in its entirety.

### BACKGROUND

1. Field

Apparatuses and methods consistent with exemplary embodiments relate to an imaging apparatus that resolves a field of view (FOV) interference which occurs when the same object is photographed using a plurality of cameras, imaging, an imaging method and a non-transitory recordable medium thereof.

2. Description of Related Art

Due to the development of electronic technology, many kinds of display apparatuses such as televisions (TVs), mobile phones, personal computers (PCs), notebook PCs, personal digital assistants (PDAs) are used in most households.

As the use of display apparatuses increases, users want these apparatuses to perform more functions. In order to meet the users' needs, manufacturers have developed products having new functions.

In particular, currently developed smart phones or tablet PCs are equipped with a plurality of cameras. These devices are equipped with cameras at a front side and a back side, making it convenient for a user to perform self-photographing or video-chatting.

However, there is a need for a product which places a plurality of cameras in the same direction. A device that utilizes a plurality of cameras photographing the same subject can be used in a wide range of areas, and thus, there is a demand for this kind of device.

### SUMMARY

One or more exemplary embodiments address at least the above problems and may provide an imaging apparatus and a control method thereof, in which an image is captured and if a field of view interference occurs, appropriate compensation is made.

In an aspect according to an exemplary embodiment, there is provided an imaging apparatus including a camera configured to capture a subject, a combiner configured to connect the imaging apparatus with another imaging apparatus, a controller configured to perform capturing by controlling the camera and the other imaging apparatus, respectively, and an image processor configured to, in response to a field of view interference occurring between the camera and the other imaging apparatus, delete an area where the field of view interference occurs, from an image captured by the camera.

The controller may be configured to determine that the field of view interference occurs in response to H>h, where h=[D−(R+r)]tan(90−Θ/2), H is a height of a lens of the other imaging apparatus, D is a distance between an optical axis of a lens of the imaging apparatus and an optical axis of a lens of the other imaging apparatus, R is a radius of a lens of the other imaging apparatus, r is a radius of a lens of the imaging apparatus, and Θ is the field of view of a lens of the imaging apparatus.

The controller may be configured to determine that the field of view interference occurs in response to tan(Θ/2)>(D−R)/H.

The imaging apparatus may further include a distance sensor configured to determine a distance between the imaging apparatus and the subject in the field of view of a lens of the imaging apparatus, and wherein the controller determines that the field of view interference occurs in response to the determined distance being in the pre-determined range.

The image processor may be configured to delete the area of the image where the field of view interference occurs, not less than x from an edge of the captured image, where x=(H−h)*Xp/H, and Xp is a length of a horizontal axis of an image captured by the imaging apparatus.

The image processor may be configured to interpolate the area of the image where the field of view interference occurs using a captured image of the other imaging apparatus.

The controller, in response to the field of view interference occurring, may be configured to change a capturing condition of at least one of the imaging apparatus and the other imaging apparatus.

The controller, in response to the field of view interference occurring, may be configured to zoom out at least one lens of the imaging apparatus and the other imaging apparatus.

The controller, in response to the field of view interference occurring, may be configured to rotate at least one lens of the imaging apparatus and the other imaging apparatus.

The controller, in response to the field of view interference occurring, may be configured to move at least one lens of the imaging apparatus and the other imaging apparatus.

A shortest distance where a lens of the other imaging apparatus moves, x, is calculated using a following equation: x=(H−h)tan(Θ/2), and h=[D−(R+r)]tan(90−Θ/2), and H is a height of a lens of the other imaging apparatus, and D is a distance between an optical axis of a lens of the imaging apparatus and an optical axis of a lens of the other imaging apparatus, and R a radius of a lens of the other imaging apparatus, and r is a radius of a lens of the imaging apparatus, and Θ is the field of view of a lens of the imaging apparatus.

In an aspect according to another exemplary embodiment, there is provided an imaging method of an imaging apparatus including capturing a subject, and in response to a field of view interference occurring between the imaging apparatus and another imaging apparatus which is connected to the imaging apparatus, an area where the field of view interference occurs is deleted from an image captured by the imaging apparatus.

The deleting the area where the field of view interference occurs may include determining that the field of view interference occurs in response to H>h, where h=[D−(R+r)]tan(90−Θ/2), H is a height of a lens of the other imaging apparatus, D is a distance between an optical axis of a lens of the imaging apparatus and an optical axis of a lens of the other imaging apparatus, R is a radius of a lens of the other imaging apparatus, r is a radius of a lens of the imaging apparatus, and Θ is the field of view of a lens of the imaging apparatus.

The deleting the area where the field of view interference occurs may include deleting the area of the image where the field of view interference occurs , not less than x from an edge of the captured image, where x=(H−h)*Xp/H, and Xp is a length of a horizontal axis of an image captured by the imaging apparatus.

The imaging method may further include an imaging apparatus, wherein if the field of view interference occurs between the imaging apparatus and the other imaging apparatus connected to the imaging apparatus, changing at least one capturing condition of the imaging apparatus and the other imaging apparatus.

The changing the capturing condition may include in response to the field of view interference occurring, zooming out at least one lens of the imaging apparatus and the other imaging apparatus.

The changing the capturing condition may include in response to the field of view interference occurring, rotating at least one lens of the imaging apparatus and the other imaging apparatus.

The changing the capturing condition may include in response to the field of view interference occurring, moving at least one lens of the imaging apparatus and the other imaging apparatus.

A distance x where a lens of the other imaging apparatus moves may be calculated using a following equation: x=(H−h)tan(Θ/2), and, h=[D−(R+r)]tan(90−Θ/2), and H is a height of a lens of the other imaging apparatus, and D is a distance between an optical axis of a lens of the imaging apparatus and an optical axis of a lens of the other imaging apparatus, and R a radius of a lens of the other imaging apparatus, and r is a radius of a lens of the imaging apparatus, and Θ is the field of view of a lens of the imaging apparatus.

A non-transitory recordable medium may record a computer program for performing an imaging method.

In an aspect according to another exemplary embodiment, there is provided an imaging apparatus including a first camera, and a second camera, and wherein a lens of the first camera has a different height than a lens of the second camera, and wherein the controller is configured to determine whether a portion of the lens of the first camera is in a field of view of the second camera, and in response to determining that a portion of the lens of the first camera is in the field of view of the second camera, adjust the first camera.

The imaging apparatus may further include a first display screen and a second display screen, wherein the first display screen is configured to display an image corresponding to the first camera and the second display screen is configured to display an image corresponding to the second camera.

The imaging apparatus may further include wherein in response to determining that a portion of the lens of the first camera is in the field of view of the second camera, the controller is configured to control the first and second display screens to display options to a user for adjusting the first camera.

The imaging apparatus may further include wherein the options to the user include at least one from among deleting an area of the image where the portion of the lens of the first camera is in the field of view of the second camera, ignoring the area of the image where the lens of the first camera in the field of view of the second camera, controlling the lens of the first camera so the first camera is not in the field of view of the second camera, interpolating the area of the image where the portion of the lens of the first camera is in the field of view of the second camera, and switching to a single capturing mode.

According to one or more exemplary embodiments, a field of view interference which occurs if the same subject is captured by a plurality of cameras may be resolved.

### BRIEF DESCRIPTION OF THE DRAWINGS

FIGS. 1 to 7 are views illustrating a combination structure or an independent structure of an imaging apparatus according to various exemplary embodiments;

FIG. 8 is a view illustrating a problem which may arise in response to a subject being photographed using a plurality of imaging apparatus;

FIG. 9 is a block diagram illustrating a configuration of a first imaging apparatus according to an exemplary embodiment;

FIG. 10 is a block diagram illustrating a configuration of a second imaging apparatus according to an exemplary embodiment;

FIG. 11 is a view illustrating a method of determining a field of view interference according to an exemplary embodiment;

FIG. 12 is a view illustrating an area where a field of view interference occurs;

FIG. 13 is a view illustrating a technology to resolve a field of view interference according to another exemplary embodiment;

FIG. 14 is a view illustrating a technology to resolve a field of view interference according to another exemplary embodiment;

FIG. 15 is a perspective view illustrating a configuration of the second imaging apparatus 200 according to another exemplary embodiment;

FIG. 16 is a drawing illustrating a technology to resolve a field of view interference according to another exemplary embodiment;

FIG. 17 is a block diagram illustrating a circuit configuration of the first imaging apparatus 100 according to an exemplary embodiment;

FIGS. 18 to 22 are views illustrating a user interface screen according to another exemplary embodiment; and

FIGS. 23 to 24 are flowcharts illustrating an imaging method according to various exemplary embodiments.

### DETAILED DESCRIPTION OF THE EXEMPLARY EMBODIMENTS

Hereinafter, exemplary embodiments will be described with reference to the accompanying drawings.

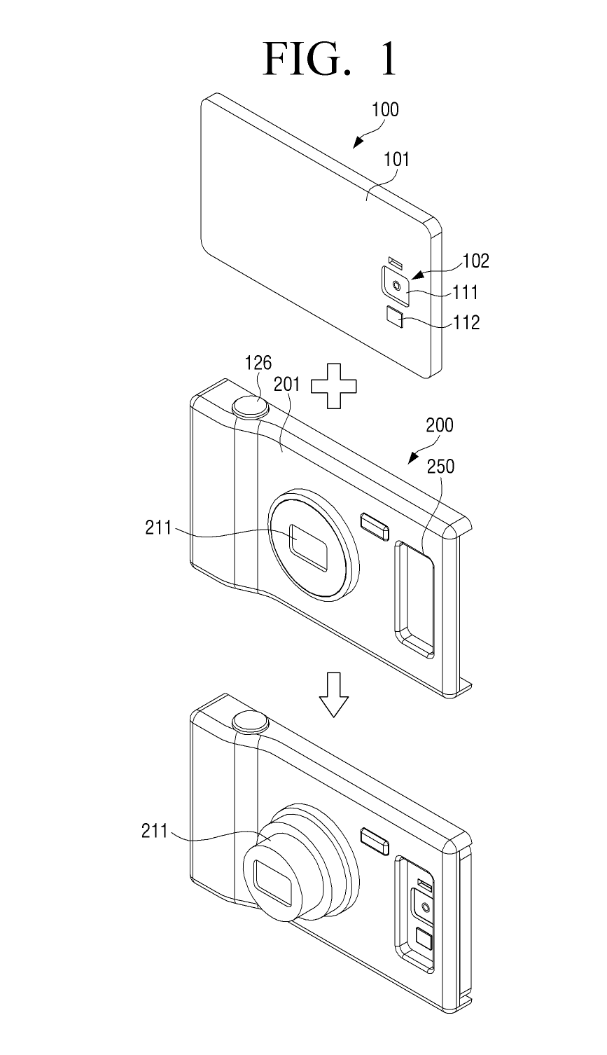

FIGS. 1 to 7 are views illustrating a combination structure or an independent structure of an imaging apparatus according to various exemplary embodiments.

FIGS. 1 to 6 illustrate a combination structure of two imaging apparatuses. For the sake of convenience, the plurality of imaging apparatuses are called a first imaging apparatus 100 and a second imaging apparatus 200. In other words, a combination structure of an imaging apparatus according to an exemplary embodiment includes the first imaging apparatus 100 and the second imaging apparatus 200.

The first imaging apparatus 100 and the second imaging apparatus 200 may be various electronic apparatuses, respectively. For example, the first imaging apparatus 100 and the second imaging apparatus 200 may be realized as various mobile apparatuses such as a digital camera, an MP3 player, a smart phone, a cellular phone, smart glasses, a tablet PC, a smart watch and the like.

An exterior configuration of the first imaging apparatus 100 and the second imaging apparatus 200 will be explained, and then a circuit configuration thereof will be explained.

As illustrated in FIGS. 1 to 6, the first imaging apparatus 100 may be a thin rectangular parallelepiped. A housing of the first imaging apparatus 100 may accommodate a lens 111 of a camera, and may open a front of the lens 111 through an opening 102 of a rear side 101. Also, a flash 112 may be provided at the periphery of the lens 111 which emits light when photographing in a dark place.

As illustrated in FIG. 1, with respect to the second imaging apparatus 200, a lens 211 may be fixed and combined with a front 201 of a housing. The lens 211 may be equipped with a zoom lens and may perform a zoom-out/out.

As illustrated in FIG. 1, the first imaging apparatus 100 and the second imaging apparatus 200 may be combined. In this case, the second imaging apparatus 200 may be designed to include a space to accommodate the first imaging apparatus 100 therein and to combine the first imaging apparatus 100 by inserting the first image apparatus into the space. The second imaging apparatus 200 may have an opening 250 to be able to photograph by opening a front of the lens 111 of the first imaging apparatus 100. The opening 250 may be formed on a housing of the second imaging apparatus 200 corresponding to a location of the lens 111 when the first imaging apparatus 100 is connected with the second imaging apparatus 200.

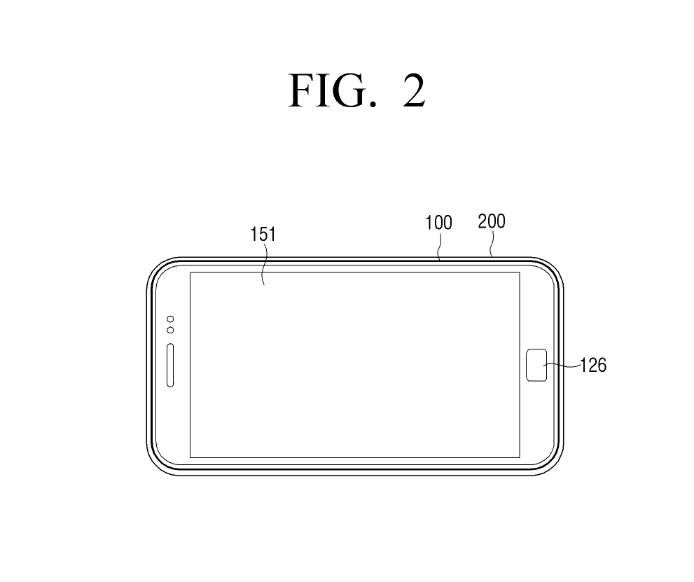

FIG. 2 illustrates a rear side of an apparatus where the first imaging apparatus 100 and the second imaging apparatus 200 are combined.

The second imaging apparatus 200 may have a space to accommodate the first imaging apparatus 100, and an upper side of the space may be opened. The first imaging apparatus 100 is combined in an opposite direction of the second imaging apparatus 200. Thus, as illustrated in FIG. 2, when the first imaging apparatus 100 is combined with the second imaging apparatus, a back side of the combined apparatus is a front side of the first imaging apparatus 100. The front side of the first imaging apparatus 100 may include a display screen 151 which displays an interface and a photographed image.

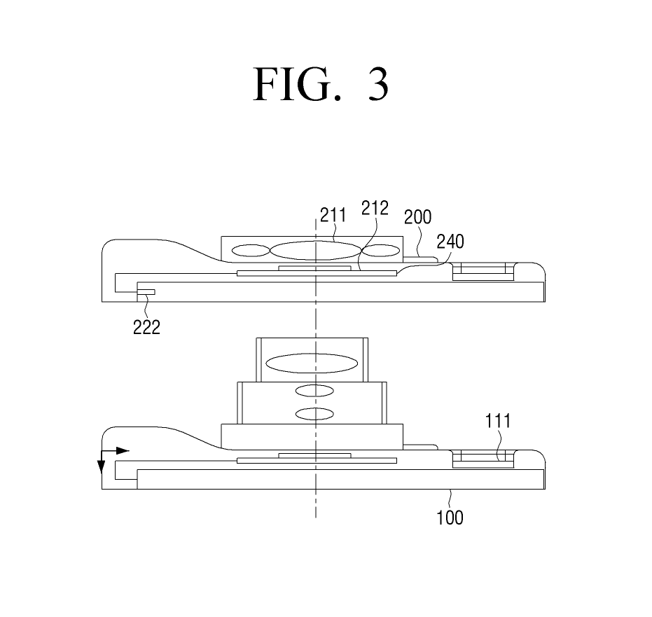

FIG. 3 is a side-sectional view illustrating an apparatus where the first imaging apparatus 100 and the second imaging apparatus 200 are combined.

As illustrated in FIG. 3, the second imaging apparatus 200 may accommodate the first imaging apparatus 100, and may be connected with the first imaging apparatus 100 through a combination terminal 222. The first imaging apparatus 100 may transmit and receive a control command and an image data, and may provide power supply to the second imaging apparatus 200 through the combination terminal 222. Meanwhile, if the second imaging apparatus 200 is equipped with separate power supply, a provision of power supply may be omitted. Also, it is possible to transmit and receive data through a separate wireless communication module without transmitting and receiving a control command and the like through the combination terminal 222.

The second imaging apparatus 200 may include a lens 211 and a solid-state imaging device 212, and be equipped with an additional image processor 240. However, it is possible for the first imaging apparatus 100 to image-process by transmitting raw image data to the first imaging apparatus 100 without the image processor 240.

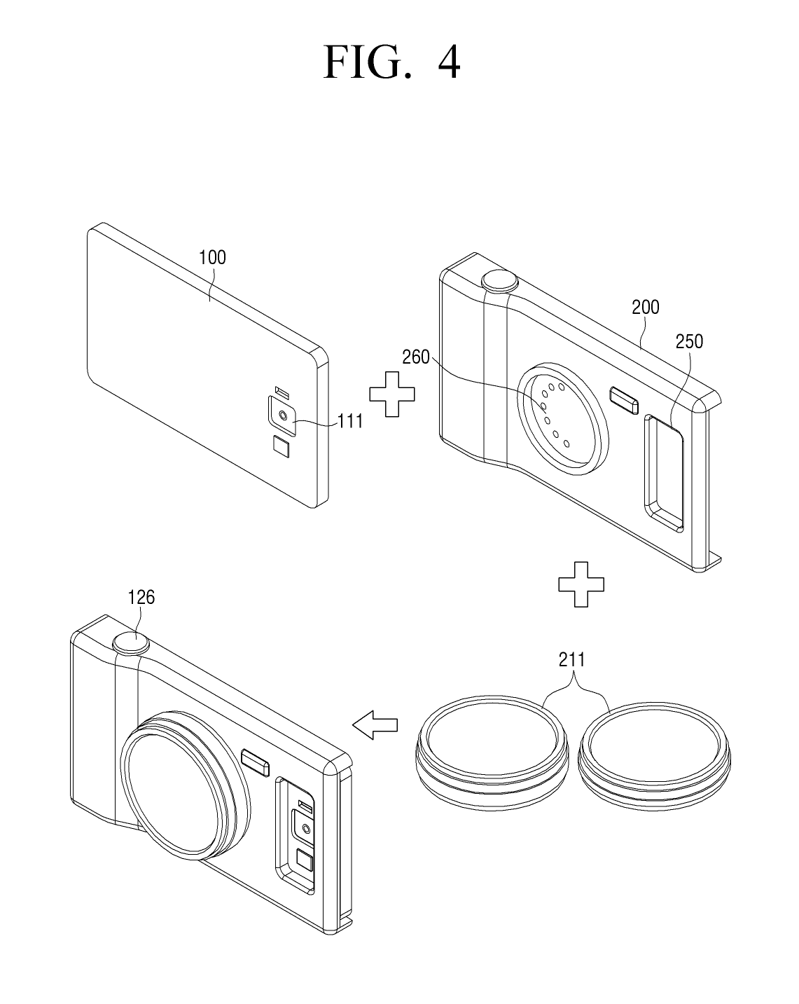

An exemplary embodiment where the lens 211 of the second imaging apparatus 200 is fixed and combined with the second imaging apparatus 200 is described above and shown in FIG. 3, but the lens 211 may also be detachable, which is illustrated in FIG. 4.

As illustrated in FIG. 4, the lens 211 may be detachable, and thus, various kinds of lenses 211 may be used by attaching and detaching according to a preferred type of image and magnification. In this case, the second imaging apparatus 200 may be equipped with an attachment groove 260 for attaching and detaching the lens 211.

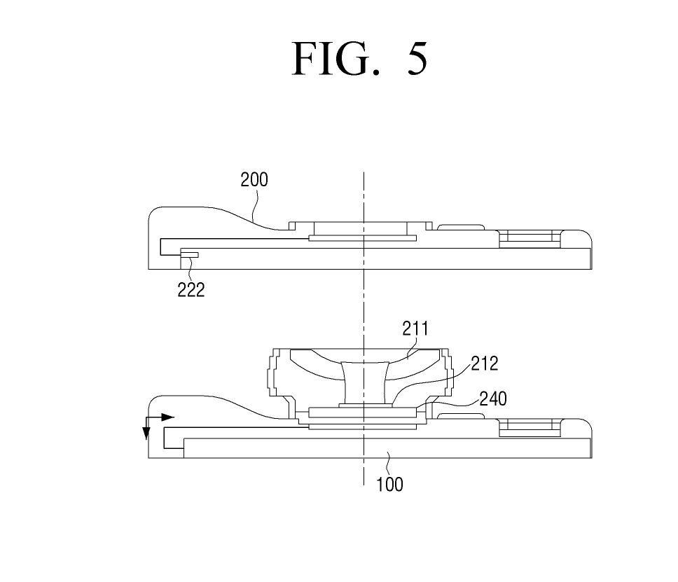

FIG. 5 is a side-sectional view illustrating an apparatus where the first imaging apparatus 100 is combined with the second imaging apparatus 200 which is able to attach and detach the lens 211.

Similar to the above exemplary embodiment, the second imaging apparatus 200 may accommodate the first imaging apparatus 100, and be connected to the first imaging apparatus through the combination terminal 222. Also, the second imaging apparatus 200 may include the lens 211 and a solid state imaging device, and be equipped with an additional image processor 240.

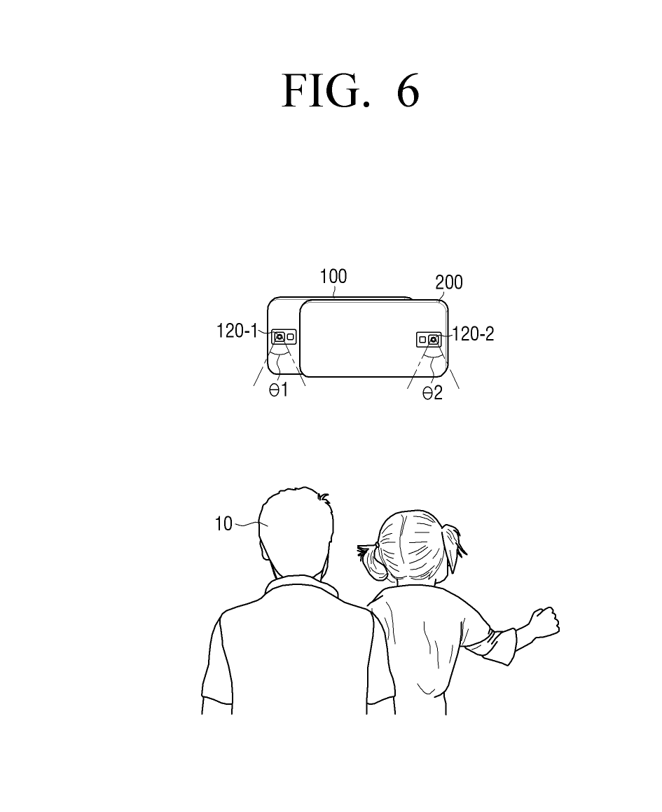

However, the first imaging apparatus 100 does not have to combine in a shape of accommodating the second imaging apparatus 200 as described above. In other words, as illustrated in FIG. 6, it is possible to combine in a shape of overlapping two imaging apparatuses. For example, if means of combination such as a magnet is equipped at a side of the first imaging apparatus and a side of the second imaging apparatus, this combination of apparatuses is possible. In this case, the first imaging apparatus 100 and the second imaging apparatus 200 are overlapped as the front sides of each camera lens are exposed.

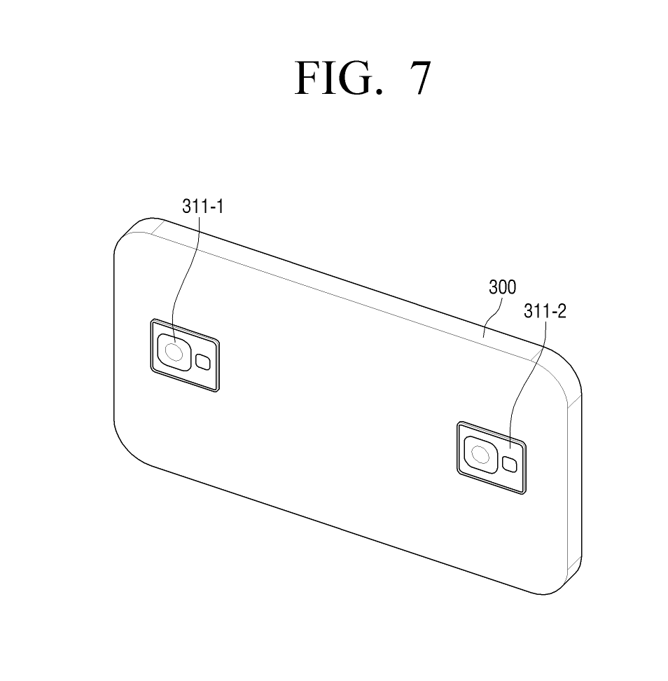

FIG. 7 is a view illustrating an exterior configuration of an imaging apparatus 300 including a plurality of cameras.

Unlike in the above-described exemplary embodiment, as illustrated in FIG. 7, the imaging apparatus 300 may include a plurality of cameras. Also, front sides of each of the lenses 311-1 and 311-2 of the plurality of cameras are exposed, and thus, it is possible to photograph the same subject simultaneously.

A function of the imaging apparatus 300 illustrated in FIG. 7, and a function of the combination structure of the first imaging apparatus 100 and the second imaging apparatus 200 described above have a similarity with respect to a feature of photographing the same subject simultaneously using a plurality of cameras. Accordingly, a problem arising from this function is also similar.

Hereinafter, explanations will be focused on the combination structure of the first imaging apparatus 100 and the second imaging apparatus 200. However, aspects of the inventive concept may also be applied to the imaging apparatus 300 including a plurality of cameras.

A problem resulting from a combination structure or an independent structure of an imaging apparatus including the plurality of photographing means is described.

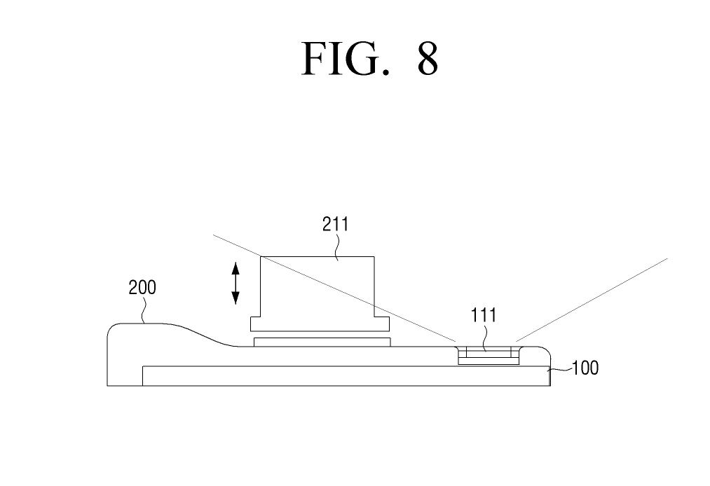

FIG. 8 is a view illustrating a problem which occurs when a subject is photographed using an apparatus connected with the plurality of imaging apparatuses described above.

If a plurality of imaging apparatuses (the first imaging apparatus and the second imaging apparatus) are connected and used, or if an imaging apparatus has a plurality of cameras, a field of view interference (KERARE) may occur. The field of view interference is a phenomenon where another lens is included in a photographic range by a difference of a field of view of the plurality of cameras so that an imaging is disturbed. An image with the field of view interference includes a shape of a lens of an another adjacent camera.

As illustrated in FIG. 8, if the lens 211 of the second imaging apparatus 200 is in the lens 111 of the first imaging apparatus 100, the lens 221 of the second imaging apparatus 200 is included in an image of a subject photographed by the lens 111 of the first imaging apparatus 100. This phenomenon mostly occurs when the lens 111 of the first imaging apparatus 100 is a wide-angle lens.

At least one of the first imaging apparatus 100 and the second imaging apparatus 200 according to various exemplary embodiments includes a technical configuration which resolves the field of view interference. An operation of each of the configurations which resolve the field of view interference along with a configuration of each of the imaging apparatus 100 is described.

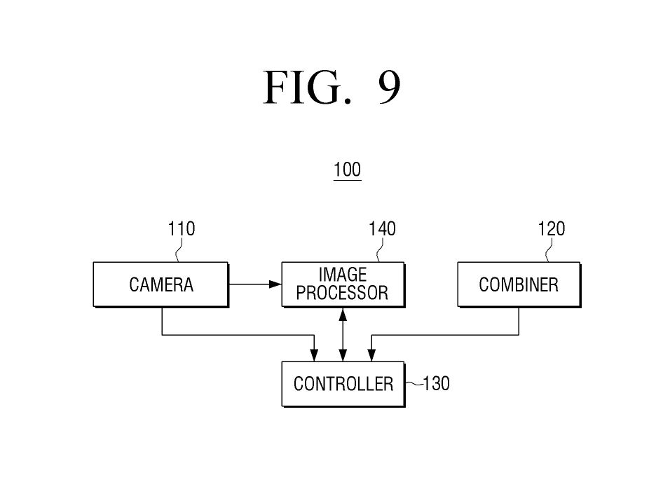

FIG. 9 is a block diagram illustrating a configuration of the first imaging apparatus 100 according to an exemplary embodiment.

Referring to FIG. 9, the first imaging apparatus 100 according to an exemplary embodiment includes a camera 110, an image processor 140, a combiner 120 and a controller 130.

The camera 110 is configured to photograph a subject and generate an image. The camera 110 includes the lens 111, a shutter, an aperture, a solid state imaging device, an analog front end (AFE) and a timing generator (TG). The shutter controls a time of which a light reflected on a subject enters the first imaging apparatus 100. The aperture controls an amount of incident rays which enters a lens by mechanically increasing or decreasing a size of an opening where a light enters. If a light reflected on a subject is accumulated as a photocharge, the solid state imaging device outputs an image made by the photocharge to an electronic signal. The TG outputs a timing signal for leading out pixel data of the solid state imaging device, and the AFE performs a sampling and digitalizes the electronic signal output from the solid state imaging device. Each of the configurations will be explained in detail afterwards.

The image processor 140 may process raw image data photographed by the camera 110 and make into YCbCr data. The image processor 140 determines an image black level, and controls a sensitivity rate according to a color. Also, the image processor 140 controls a white balance, and performs a gamma correction, a color interpolation, a color compensation, and a resolution conversion. If the field of view interference occurs, the image processor 140 may delete or interpolate an area of an image where the field of view interference occurs.

The controller 130 controls an overall operation of the imaging apparatus 100. The controller 130 controls the camera 100 and then acquires raw image data, and controls the image processor 140 and then displays a live view image on a display unit. If a command to photograph such as pressing a shutter, and the like, is received, the controller 130 controls the image processor to image-process the raw data and to generate a still image. The controller 130 determines whether a field of view interference occurs, and if the field of view interference occurs, the controller may delete or interpolate an area of an image where the field of view interference occurs by controlling the image processor 140. Also, a photographing condition of the first imaging apparatus 100 or the second imaging apparatus 200 may be changed.

The combiner 120 is configured to combine the first photographing apparatus 100 and the second photographing apparatus 200. The combiner 120 may include various technical configurations to make a physical combination possible. A physical combination structure is described above, and thus, a redundant explanation is omitted.

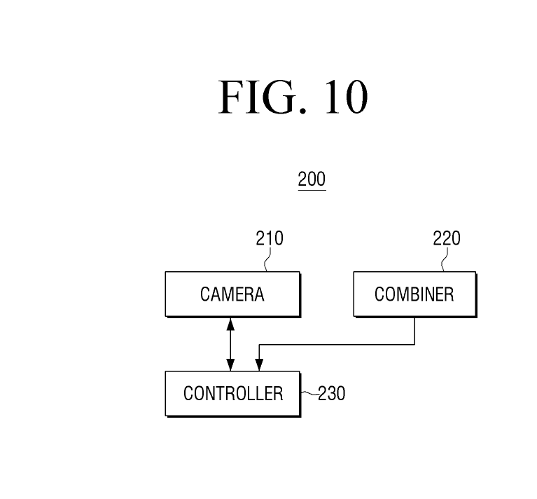

FIG. 10 is a block diagram illustrating a configuration of the second imaging apparatus 200 according to an exemplary embodiment.

Referring to FIG. 10, the second imaging apparatus 200 according to an exemplary embodiment includes a camera 210, a combiner 220 and a controller 230.

With respect to the same configuration with the first imaging apparatus 100 thereof described above, a redundant explanation is omitted.

The camera 210 of the second imaging apparatus 200 may be equipped with a different lens from the first imaging apparatus 100. For example, the camera 210 may include a thin telephoto lens.

Also, as illustrated in FIG. 10, the second imaging apparatus 200 may exclude an image processor. However, as illustrated in FIGS. 3 and 5, the image processor 240 may be included. In an exemplary embodiment of FIG. 9, an image photographed by the second imaging apparatus 200 may be image-processed by the first imaging apparatus 100.

The second imaging apparatus 200 may further include a communicator to transmit or receive a photographed image or a control command.

Hereinafter, a determination of a field of view interference of the first imaging apparatus 100, and a technical configuration of the first imaging apparatus and the second imaging apparatus to resolve the field of view interference are explained.

The controller 130 of the first imaging apparatus 100 may determine whether a field of view interference occurs in various ways.

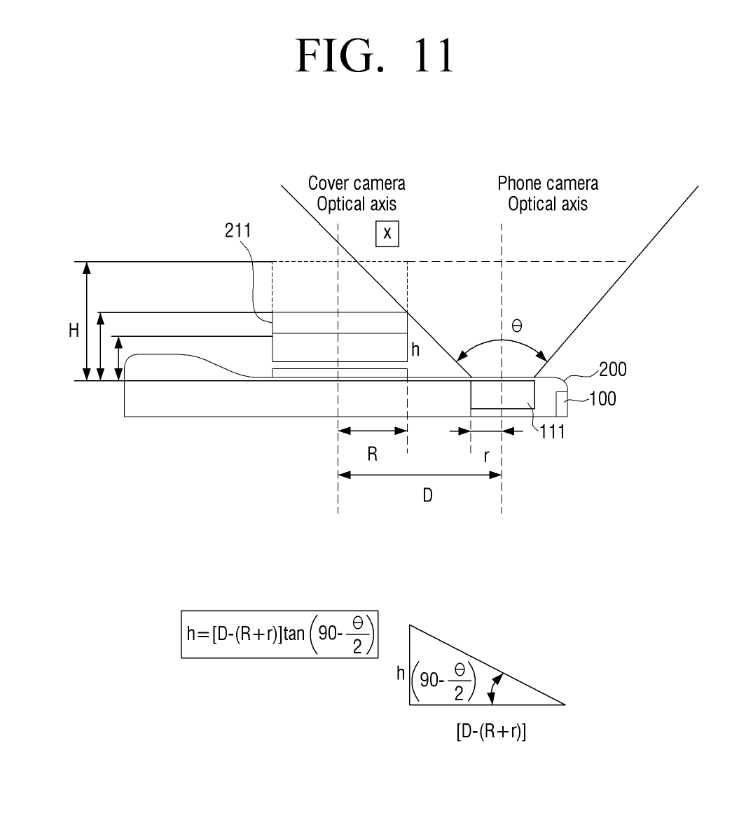

FIG. 11 is a view illustrating a method of determining a field of view interference according to an exemplary embodiment.

In FIG. 11, a field of view Θ of the lens 111 of the camera 110 is fixed, and thus, if a height H of the lens 211 of the second imaging apparatus 200 is in a range of the field of view Θ, the controller 130 may determine that the field of view interference occurs. Parameter information below such as a height H of the lens 211 may be known easily, and thus, in an equation below, in response to H>h, it may be determined that the field of view interference occurs.

[D−(R+r)]tan(90−Θ/2)

H: a height of a lens of the second imaging apparatus

D: a distance between an optical axis of a lens of the imaging apparatus and an optical axis of a lens of the another imaging apparatus

R: a radius of a lens of the second imaging apparatus

r: a radius of a lens of the first imaging apparatus

Θ: a field of view of a lens of the first imaging apparatus

The controller 130 is able to determine whether a field of view interference occurs by determining another equation besides the above equation. For example, in response to tan(Θ/2)>(D−R)/H, the controller 130 may determine that a field of view interference occurs.

The controller 130 may also determine whether a field of view interference occurs without determining an equation condition. For example, if an image with a pre-determined pixel value is included in an edge area in a direction of the lens 211 of the second imaging apparatus 200 of an edge of a raw data image photographed by the camera 110, the controller 130 may determine that a field of view interference occurs. For example, a pixel value of an area where a field of view interference occurs is exceptionally dark in comparison with other areas, and a variation of a pixel in a boundary surface of the field of view interference is substantial, and thus, the controller 130 may easily determine the field of view interference.

The first imaging apparatus 100 may further include a distance sensor for determining a field of view interference. The distance sensor may be realized as one of a distance ultrasonic wave sensor, an infrared ray sensor, and an electromagnetic wave sensor. The distance sensor radiates an ultrasonic wave and the like to an object, and receives a reflected ultrasonic wave and the like, and thus, calculates a distance from the object. If the distance from the object is in a pre-determined range, it may be determined that the ultrasonic wave and the like is reflected to a surface of a lens and then returned, and thus, it may be determined that a field of view interference occurs. However, if a distance from the object is outside a pre-determined range, it may be determined that the ultrasonic wave and the like is reflected on another object besides a surface of a lens, and thus, it is possible to determine that a field of view interference does not occur.

If a field of view interference does not occur, the image processor 140 performs a usual image process. However, if it is determined that a field of view interference occurs, the image processor 140 may delete an area of an image where the field of view interference is generated.

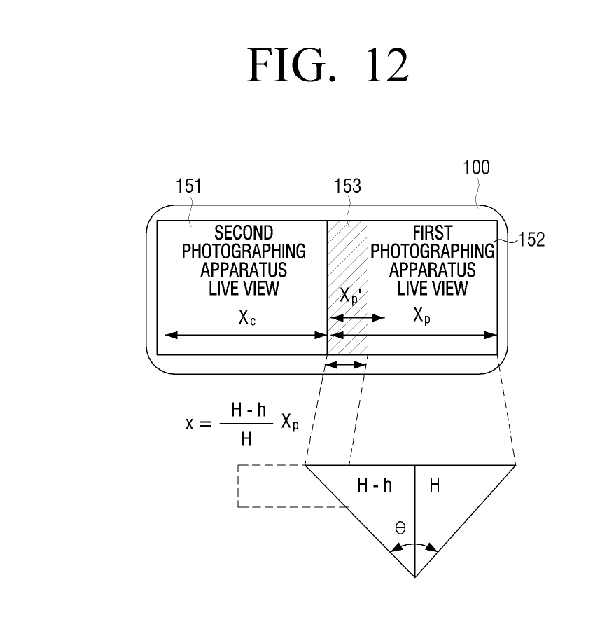

FIG. 12 is a view illustrating an area where a field of view interference occurs.

As illustrated in FIG. 12, a live view image of the second imaging apparatus 200 may be displayed in a first area 151 of a display screen, and a live view image of the first imaging apparatus 100 may be displayed in another area 152.

In FIG. 12, if a length of a horizontal axis of an image photographed by the first imaging apparatus 100 is Xp, a horizontal axis x of an area where a field of view interference occurs may be shown as an equation below.

X=(H−h)*Xp/H

The definition of each parameter is the same above.

The image processor 140 may delete an image 153 of an area which reaches to the x length of the horizontal axis in a left side edge of the image. The image processor 140 stores an image where the image of an area which reaches to the x length of the horizontal axis in a left side of an image is deleted from an original image, in a buffer. The display unit reads and outputs the image stored in the buffer.

In addition to removing the image 153 of an area which reaches to the x length of the horizontal axis in the left side edge, an image of an area which reaches to the x length of the horizontal axis in a right edge may also be deleted. Also, an image of an area which reaches to the x length of the vertical axis in an upper side edge or a lower side edge may be deleted together. In this case, a subject is located in the center of a final image, and thus, a more natural image may be acquired.

It is also possible to interpolate without removing a part of an image (or delete an image and interpolate the deleted area). If the first imaging apparatus 100 photographs the same subject as the second imaging apparatus 200 (this is defined as a dual photographing mode), an image photographed by the second imaging apparatus 200 includes an image area corresponding to an area where the field of view interference occurs, and thus, it may allow an image of an area where the field of view interference occurs to be interpolated. The first imaging apparatus 100 receives an image photographed from the second imaging apparatus 200, the image processor 140 detects an area corresponding to an area where the field of view interference occurs in the received image, and restores an area of an image area where the field of view interference occurs using a pixel value of the detected area. A finally generated image is stored in a buffer and displayed by a display unit 150.

If it is determined that a field of view interference occurs, it is possible to change the zoom of the lens 211 of the second imaging apparatus 200 without image-processing described above and avoid the field of view interference.

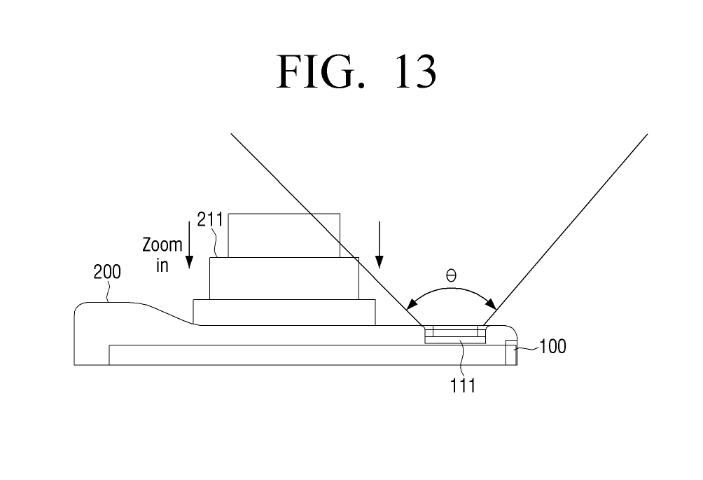

FIG. 13 is a view illustrating a technology to resolve a field of view interference according to another exemplary embodiment.

If it is determined that a field of view interference occurs, the first imaging apparatus 100 may control the second imaging apparatus 200 connected to the first imaging apparatus, and zoom out the lens 211 of the second imaging apparatus, and avoid the field of view interference. In other words, as illustrated in FIG. 13, if the lens 211 of the second imaging apparatus 200 is in a range of a field of view of the first imaging apparatus 100, the first imaging apparatus may determine whether the lens 211 of the second imaging apparatus 200 is in a range of a field of view of the first imaging apparatus 100, and pull the lens 211 of the second imaging apparatus 200 to a range where the field of view does not occur.

If the second imaging apparatus 200 is not controlled by the first imaging apparatus 100, the first imaging apparatus 100 may notify that a field of view interference occurs to the second imaging apparatus 200. If the controller 230 of the second imaging apparatus 200 receives this information, the lens 211 may be zoomed out to a range where the field of view interference does not occur.

If the lens 211 is zoomed out because of a field of view interference which occurs as above, a photographic environment of the second imaging apparatus 200 is changed, and thus, this information may be notified to a user by displaying this information on a display unit.

In a case of entering into a dual photographing mode which photographs a subject using a plurality of cameras, the controller 130 may perform a prevention function which sets a photographic environment automatically so that a field of view interference does not occur.

In other words, in a case of entering into a dual photographing mode which photographs a subject using a plurality of cameras, if a zooming operation which generates a field of view interference is performed, the controller 130 may limit the zooming so that it is performed in a range where the field of view does not occur. Also, if a single photographing mode which performs photographing separated from the second photographing apparatus 200 or performs photographing using a single camera is set, and a field of view interference occurs by entering into a dual photographing mode, an operation of zooming in a range where the field of view interference does not occur may be performed.

Unlike in the above-described exemplary embodiment, if it is determined that a field of view interference occurs, a lens of the first imaging apparatus 100 or the second imaging apparatus is rotated, and thus, the field of view interference may be avoided.

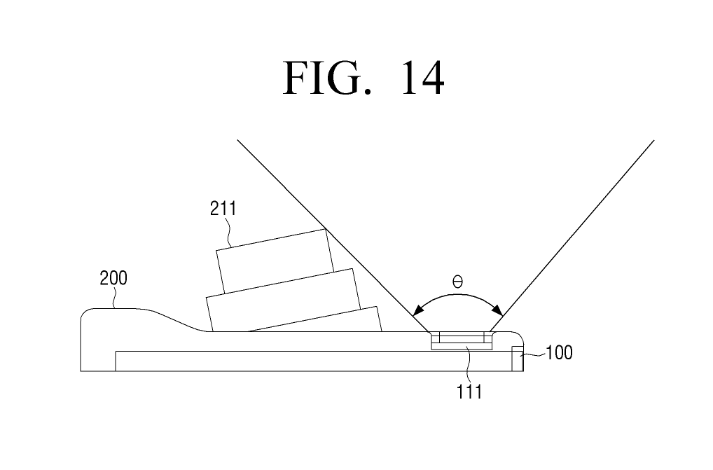

FIG. 14 is a view illustrating a technique to resolve a field of view interference according to another exemplary embodiment.

As illustrated in FIG. 14, the lens 211 of the second imaging apparatus 200 according to yet another exemplary embodiment may be realized to be rotatable. As illustrated in FIG. 14, if the lens rotates to the left, a left edge of the lens 211 is inserted into an inside of the second imaging apparatus 200, and a right edge is protruding to a front side of the second imaging apparatus 200.

The second imaging apparatus 200 may include various mechanical configurations for photographing of the lens 211. The second imaging apparatus 200 may include mechanical configurations, for example, an actuator such as a motor for rotational driving, a sensor such as an encoder to know a rotation angle, a bearing for a smooth rotation and a stopper for limiting a maximum rotation angle.

If it is determined that a field of view interference occurs, the first imaging apparatus 100 may control the second imaging apparatus 200 which is connected to the first imaging apparatus, rotate the lens 211 of the second imaging apparatus 200, and avoid the field of view interference. In other words, as illustrated in FIG. 14, if the lens 211 of the second imaging apparatus 200 is in a field of view range of the lens 111 of the first imaging apparatus 100, the first imaging apparatus 100 determines whether the lens 211 of the second imaging apparatus 200 is in a field of view range of the lens 111 of the first imaging apparatus 100, and rotates the lens 211 of the second imaging apparatus 200 to place the lens 211 of the second imaging apparatus 200 outside the field of view range of the lens 111 of the second imaging apparatus 200.

If the second imaging apparatus 200 is not controlled by the first imaging apparatus 100, the first imaging apparatus 100 may notify the second imaging apparatus 200 that a field of view interference occurs. If this information is received, the controller 230 of the second imaging apparatus 200 may rotate the lens 211 to a range where the field of view interference does not occur as above.

The first imaging apparatus 100 may determine a field of view as above, but a user may actually confirm the field of view interference through an electronic view finder image of the first imaging apparatus 100. In this case, the user may manually rotate the lens 211 of the second imaging apparatus 200 and avoid the field of view interference.

In addition to the above-described exemplary embodiment, it is also possible to make determination regarding a field of view interference automatically, but to avoid the field of view interference manually.

If the lens 211 is rotated because of a field of view interference as above, a photographic environment of the second imaging apparatus 200 is changed, and thus, this information may be displayed on a display unit and a user may be notified.

In the above exemplary embodiment, it is explained that if a field of view interference occurs, the lens 211 of the second imaging apparatus 200 is rotated, but the lens 111 of the first imaging apparatus may be rotated. Also, it is possible to rotate the lens 111 of the first imaging apparatus 100 and the lens 211 of the second imaging apparatus 200, and avoid the field of view interference.

In a case of entering into a dual photographing mode which photographs a subject using a plurality of cameras, the controller 130 may perform a prevention function which sets a photographic environment automatically so that a field of view interference does not occur.

In other words, in a case of entering into a dual photographing mode, if an operation is performed in which a field of view interference occurs (for example, a zooming operation), the controller 130 may rotate the lens 211 or 111 to a range where the field of view interference does not occur. Also, if a single photographing mode which performs photographing separate from the second photographing apparatus 200 or performs photographing using a single camera is set and if a field of view interference occurs by entering into a dual photographing mode, an operation of rotating the lens 211 or 111 to a range where the field of view interference does not occur may be performed.

Unlike in the above-described exemplary embodiment, if it is determined that a field of view interference occurs, a lens of the second imaging apparatus may be moved so that the field of view interference is avoided.

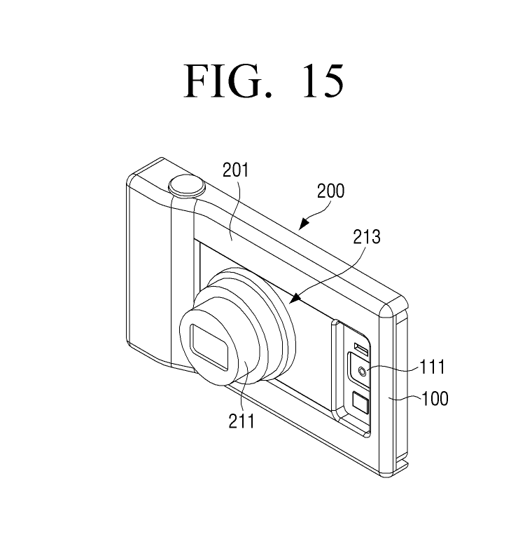

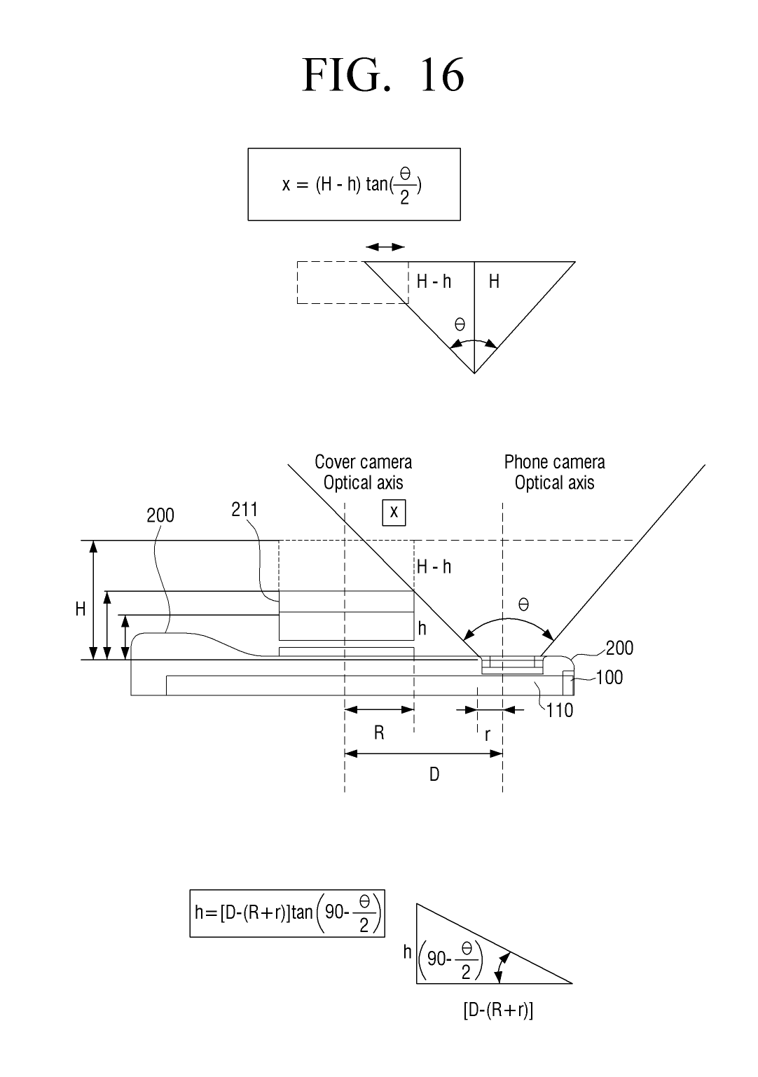

FIG. 15 is a perspective view illustrating a configuration of the second imaging apparatus 200 according to another exemplary embodiment, and FIG. 16 is a view illustrating a technique to resolve a field of view interference according to the other exemplary embodiment.

As illustrated in FIG. 15, the lens 211 of the second imaging apparatus 200 according to other exemplary embodiment is realized to be able to move above the housing 201 of the second imaging apparatus 200. The lens 211 is installed in a pocket 213 of the housing 201 of the second imaging apparatus 200 and is possible to move. The pocket 213 may be set at a pre-determined depth and include a moving rail which accommodates a part of the lens 211 and allows the lens 211 to be moved. The lens 211 may be moved in a horizontal direction or in a vertical direction according to the moving rail. Unlike this, the second imaging apparatus 200 may include another technical configuration which accommodates a part of the lens 211 and allows the lens 211 to be moved.

In addition, the second imaging apparatus 200 may include configurations such as an actuator such as a motor for a linear movement of the lens 211 (for example, a linear motor, a pzt motor and the like), a displacement sensor to know a moving distance, a rotational mechanical elements to help the linear movement (a linear slide, a bearing, a guide shaft and the like), a rack pinion gear configuration for converting a rotational movement to a linear movement if a motor is used, and a stopper for a maximum displacement limitation.

If it is determined that a field of view interference occurs , the first imaging apparatus 100 may control the second imaging apparatus 200 which is connected to the first imaging apparatus, move the lens 211 of the second imaging apparatus 200, and avoid the field of view interference. In other words, as illustrated in FIG. 16, if the lens 211 of the second imaging apparatus 200 is in a range of a field of view of the lens 111 of the first imaging apparatus 100, the first imaging apparatus 100 may determine this and move the lens 211 of the second imaging apparatus 200 so that the lens 211 of the second imaging apparatus 200 is placed outside the field of view range of the lens 111 of the first imaging apparatus 100.

If the second imaging apparatus 200 is not controlled by the first imaging apparatus 100, the first imaging apparatus 100 may notify the second imaging apparatus 200 that a field of view interference occurs. If a controller of the second imaging apparatus 200 receives this information, the lens 211 may be moved to a range where the field of view interference does not occur.

If a distance that the lens 211 moves is called x, then it can be calculated using a following equation.

x=(H−h)tan(Θ/2)

H: a height of a lens of the second imaging apparatus where a field of view interference occurs

h: a height of a lens of the second imaging apparatus where a field of view interference does not occur

Θ: a field of view of a lens of the first imaging apparatus

h=[D−(R+r)]tan(90−Θ/2) may also be used.

As illustrated in FIG. 16, the lens 211 of the second imaging apparatus 200 may be moved up to x in a left direction and avoid a field of view interference.

However, it may also be realized that the lens 111 of the first imaging apparatus 100 moves and avoids a field of view interference.

The first imaging apparatus 100 may determine a field of view interference automatically as described above, but a user may actually confirm the field of view interference through an electronic view finder image of the first imaging apparatus 100. In this case, the user may manually move the lens 211 of the second imaging apparatus 200 and avoid the field of view interference.

In a case of entering into a dual photographing mode which photographs a subject using a plurality of cameras, the controller 130 may perform a prevention function which sets a photographic environment automatically so that a field of view interference does not occur.

In other words, in a case of entering into a dual photographing mode, if an operation is performed in which a field of view interference occurs (for example, a zooming operation), the controller 130 may move the lens 211 to a range where the field of view interference does not occur. Also, if a single photographing mode which performs photographing separate from the second photographing apparatus 200 or performs photographing using a single camera is set and a field of view interference occurs by entering into a dual photographing mode, an operation of moving the lens 211 to a range where the field of view interference does not occur may be performed.

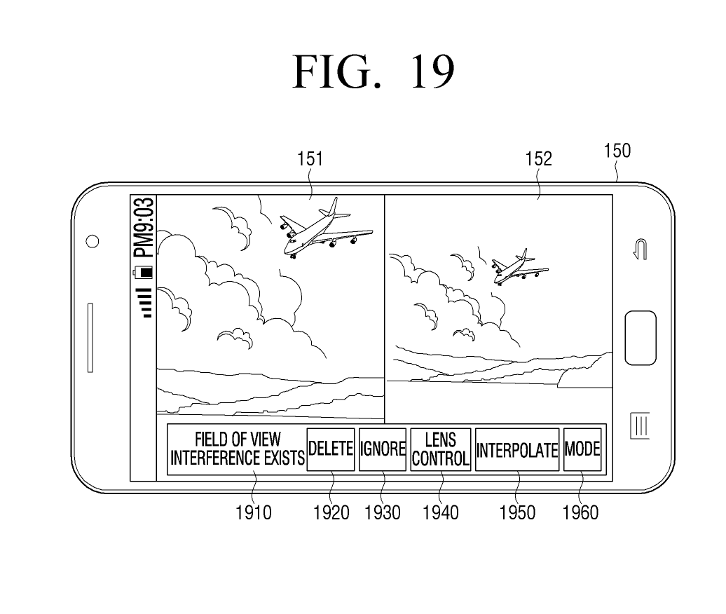

If a field of view interference occurs, the controller 130 may be converted from a dual photographing mode to a single photographing mode. In this case, a user interface which inquires whether to photograph in a single photographing mode to a user is output, and if the user selects a single photographing mode or a dual photographing mode, a selected mode is set (see FIG. 19).

Hereinafter, a detailed configuration of the first imaging apparatus 100 and the second imaging apparatus 200 is explained. For the sake of convenience, the first imaging apparatus is explained mainly. The second imaging apparatus 100 may be formed by omitting or adding some configurations.

Exemplary embodiments in FIGS. 13-16 described above may include an exemplary embodiment where the image processor 140 processes a field of view interference, and the first imaging apparatus 100 may function independently or combined with the above exemplary embodiment. In other words, the controller 130 of the first imaging apparatus 100 may be realized like the exemplary embodiments in FIG. 11-12, rather than the exemplary embodiments in FIGS. 13-16. The controller 130 of the first imaging apparatus 100 may be realized as the exemplary embodiments in FIGS. 11-12 and control an operation of the image processor 140. In other exemplary embodiments, it is possible for all exemplary embodiments described above to be realized together. Each of the exemplary embodiments in FIGS. 13-16 may also be realized independently.

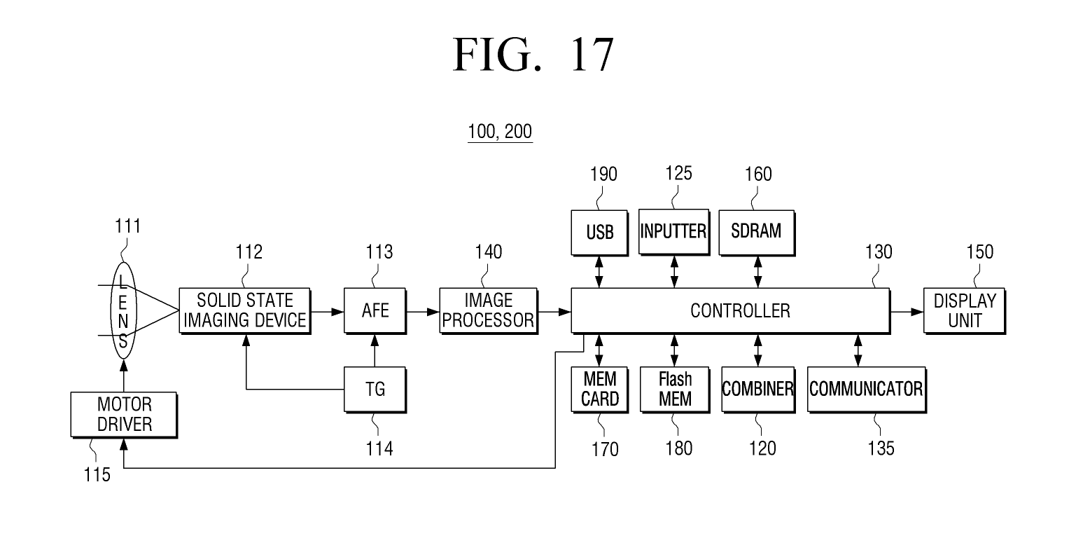

FIG. 17 is a block diagram illustrating a circuit configuration of the first imaging apparatus 100 according to an exemplary embodiment.

Referring to FIG. 17, the first imaging apparatus 100 according to an exemplary embodiment includes the lens 111, a solid state imaging device 112, a timing generator (TG) 114, an analog front end (AFE) 113, a motor driver 115, a controller 130, a USB module 190, a SDRAM module, a memory card 170, a flash memory 180, the display unit 150, an inputter 125, the combiner 120 and the communicator 135.

The lens 111 is configured to project rays reflected on a subject and includes at least one of a zoom lens and focus lens. The first imaging apparatus 100 may further include an aperture.

The aperture is configured to control an amount of incident light which comes into the inside of the first imaging apparatus 100 through the lens 111. The aperture includes a mechanical structure to gradually increase or decrease a size of an opening to control the incident rays. The aperture may display a degree of opening by a numerical value of the aperture which is called F. The smaller the value of the aperture, the larger a size of the opening, and thus, the amount of incident rays may become greater, generating brighter images.

The solid state imaging device 112 is configured to form an image of a subject which passes through the lens 111. The solid state imaging device includes a plurality of pixels which is placed in a shape of a matrix. Each of the plurality pixels accumulates a photocharge according to incident rays and outputs an image made by the photocharge to an electronic signal. The solid state imaging device 112 may be comprised of a complementary metal oxide semiconductor (CMOS) or a charge coupled device (CCD).

The solid state imaging device 112 may include a photo diode (PD), a transmission transistor (TX), a reset transistor (RX) and a floating diffusion node (FD). The photo diode (PD) generates and accumulates a photocharge corresponding to an optical image of a subject. The transmission transistor (TX) responds to a transmission signal and then, transmits the photocharge generated in the photo diode (PD) to the floating diffusion node (FD). The reset transistor (RX) responds to a reset signal and emits an electric charge stored in the floating diffusion node (FD). The electronic charge stored in the floating diffusion node (FD) is output before the reset signal is approved, and in a case of a correlated double sampling (CDS) image sensor, a CDS process is performed. ADC converts an analog signal of which the CDS process is performed to a digital signal.

The timing generator (TG) 114 outputs a timing signal to readout pixel data of the solid state imaging device 112. The TG 114 is controlled by the controller 130.

An analog front end (AFE) 113 performs a sampling to an electronic signal of a subject image output from the solid state imaging device 112. The AFE 113 is controlled by the controller 130.

The AFE 113 and the TG 114 may be planned with another configuration which is able to be replaced, particularly if the solid state imaging device 112 is realized as a type of CMOS.

The motor driver 115 reads out a phase difference pixel, drives a focusing lens based on the calculated information and takes a focus. Meanwhile, if the first imaging apparatus 100 is realized as a smart phone or a cellular phone, it may be processed with software without driving a lens for focusing, so the motor driver 115 might not be provided.

The image processor 140 may image-process a raw image data by a control of the controller 130, record the image-processed data on a synchronous dynamic ram (SDRAM) 160 and transmit an image-processed data of the SDRAM 160 to the display unit.

If an auto focusing using a phase difference is performed, the image processor 140 separates a signal for generating an image (a signal which is readout from a general pixel) and a signal for calculating a phase difference out of signals which is output from the solid state imaging device 112 and sampled by the AFE 113. This is to calculate a phase difference quickly using the signal for calculating a phase difference, generate an image such as a live view in parallel and perform an auto focusing quickly.

Meanwhile, the first imaging apparatus 100 according to various exemplary embodiments described above is not limited to an auto focusing technology using a phase difference pixel. For example, the first imaging apparatus 100 according to various exemplary embodiments may further include a technical configuration which performs a contrast auto focusing.

The image processor 140 processes a raw image data and converts it to YCbCr. A pixel defect of the raw image data is corrected by a correction circuit. The correction circuit corrects the pixel defect referring to a correction table, and an address of a pixel which includes a defect is registered in the correction table. A correction is performed to a pixel corresponding to the address from surrounding pixels.

The image processor 140 includes an optical black (OB) clamping circuit which determines a black level of an image. The solid state imaging device 112 is in an OB area, detects an average value of signals in the OB area, and determines a black level through a difference of each pixel value.

The image processor 140 performs a control of sensitivity rate which is different according to colors using a sensitivity rate control circuit. The sensitivity rate control circuit controls sensitivity of R color, G color, and B color under a standard light source. In general, a gain value of G is fixed to 1, and sensitivity of R and B is adjusted to this.

If a still image is output, after controlling a sensitivity rate, image data is output through an output buffer. In this case, an image is generated by an interlace method, and thus, it is not possible to do a post-process immediately. However, if a live view image is output, an image is generated in a progressive method, and thus, it is possible to do a post-process immediately.

The image processor 140 performs a skip readout which reads out a part of pixel line and skips remaining pixel lines using a horizontal skip readout circuit, and thus, the number of pixels of a raw image decreases. In particular, if the first imaging apparatus needs to quickly display a live view image of which a field of view interference occurs, a real-time photographed image may be displayed through a skip readout method.

The image processor 140 controls a white balance (WB) with respect to an image data using a WB control circuit. A spectrum distribution of an illumination light is different according to a photographic environment, and thus, even if a white subject is photographed, it may not be displayed as white. Each of R, G and B pixels are given a different gain value, and a signal level is adjusted. In general, a gain value of G is fixed to 1, and signal level of R and B is adjusted to this.

The image processor 140 performs a gamma correction with respect to image data. A tone conversion corresponding to an output of the display unit 150 is performed through the gamma correction.

The image processor 140 generates a general color image signal comprising three colors per a single pixel from a Bayer signal comprising a single color per a single pixel using a color interpolation circuit.

A color space conversion and a color correction corresponding to an output are performed using a color space conversion circuit and a color correction circuit. A look up table (LUT) may be used as occasion demands. After the color space conversion and the color correction, image data becomes YCbCr data.

The image processor 140 converts a resolution and adjusts a size using a resolution conversion circuit.

The image processor 140 processes a spatial filter with respect to an image data using a special filter circuit. An edge enhancement of a Y signal is performed, and a low pass filter (LPF) process of a Cb/Cr signal is performed.

The image processor 140 performs a skip readout with respect to a Cb/Cr signal using a Cb/Cr skip readout circuit and converts to image data of YCbCr 4:2:2.

In case of a still image, a readout may be performed in an interlace method, but an adjacent pixel line does not exist so a color interpolation cannot be processed directly. Accordingly, after a preprocessing is finished, an order of a pixel line is adjusted and stored in the SDRAM 160 in a progressive shape. This image data is read again and inputted to the image processor 140 through an input buffer.

However, the exemplary embodiment is not limited to the interlace method in a case of a still image, and it may be realized as a progressive method to readout.

In a case of a still image, it is necessary to generate a preview image or a thumbnail image. A part of pixel data is omitted as the skip readout.

The image processor 140 interpolates a phase difference pixel part with a general pixel value using an AF signal interpolation circuit. The phase difference pixel is placed in between a general pixel, and thus, if this part is used as it is, a resolution degradation may occur. Accordingly, an interpolation is performed using adjacent pixels.

A signal of a phase difference pixel separated from a separating circuit is recorded on the SDRAM 160 through the first bus. A readout with respect to a plurality of pixels are performed and then a separation is performed, and thus, each of the phase difference pixel signals are accumulated in the SDRAM 160 for a short period.

The stored phase difference pixel signal is input to a phase difference arithmetic circuit through the first bus. The phase difference arithmetic circuit calculates a phase difference between phase difference pixels, and also calculates a direction and an amount of movement of a focus lens. The calculated amount of movement is recorded on a register in the phase difference arithmetic circuit temporarily, and the controller 130 (that is a CPU) reads.

The controller 130 reads the calculated amount of movement of a focus lens and generates a control command. The generated control command is transmitted to the motor driver 115 and drives a focus lens. However, as described above, the first imaging apparatus may not be equipped with the motor driver 115.

A JPEG codec compresses YCbCr data. The compressed image data is recorded on the SDRAM 160. The controller 130 reads the compressed image data recorded on the SDRAM 160 and records on the memory card 170 so that an image generating process is finished.

If a field of view interference between the first imaging apparatus 100 and the second photographing apparatus 200 occurs, the first image processor 140 deletes an area where the field of view interference occurs from the photographed image. The image processor 140 performs cropping which deletes an image of an area where a field of view interference occurs from an image recorded on the memory card 170, and stores result image data in the memory card 170.

At this moment, the image processor 140 may delete an image of an area up to x from an edge of the photographed image, and x is calculated using an equation below.

x=(H−h)*Xp/H

h=[D−(R+r)]tan(90−Θ/2)

H: a height of a lens of the second imaging apparatus

D: a distance between an optical axis of a lens of the imaging apparatus and an optical axis of a lens of the another imaging apparatus

R: a radius of a lens of the second imaging apparatus

r: a radius of a lens of the first imaging apparatus

Θ: a field of view of a lens of the first imaging apparatus

Xp: a length of a horizontal axis of an image photographed by the first imaging apparatus 100

At this moment, removing the image 153 of an area which reaches to the x length of the horizontal axis in the left side edge, and also removing an image of an area which reaches to the x length of the horizontal axis in a right edge. Also, an image of an area which reaches to the x length of the vertical axis in an upper side edge or a lower side edge may be deleted together. In this case, a subject is located in the center of a final image, and thus, a more natural image may be acquired.

The image processor 140 may interpolate an image of an area where the field of view interference is generated using a photographed image of the second imaging apparatus 200. The second imaging apparatus 200 may photograph the same subject as the first imaging apparatus 100 (dual photographing mode). A field of view interference may occur in a lens of the first imaging apparatus, but the field of view interference may not occur in a lens of the second imaging apparatus 200. Accordingly, the second imaging apparatus 200 acquires an intact image without a field of view interference. The controller 130 receives an image of the second imaging apparatus 200 and interpolates an area where a field of view interference of the first imaging apparatus. The interpolated image is stored in the memory card 170.

The communicator 135 is configured to perform a communication with another apparatus. In particular, the communicator 135 may perform a communication with the second imaging apparatus 200. The communicator 135 may transmit a control command or transmit and receive image data to and from the second imaging apparatus 200. If the second imaging apparatus 200 is controlled by the first imaging apparatus 100, the communicator 135 transmits a control command to the second imaging apparatus 200. Also, the second imaging apparatus 200 may transmit a photographed image to the first imaging apparatus 100 using the communicator 135. A transmitted photographed image may be a live view image, a still image, etc. The image may be displayed through the display unit 150 of the first imaging apparatus 100.

In particular, the communicator 135 may receive information regarding a photographic condition from the second imaging apparatus 200 to determine a field of view interference. For example, at least one of zoom-in/out information of the second imaging apparatus 200, and information regarding radius of a lens may be received.

The communicator 135 may be realized as various wireless communication technologies. The communicator 135 may include a short-distance communication module which performs a communication directly without a repeater between devices. If the communicator 135 is realized as a wire communication module, it may be included as a partial configuration of the above-described combiner 120.

The communicator 135 may include at least one of a wifi direct communication module, a Bluetooth module, an infrared data association (IrDA) module, a near field communication (NFC) module, and a zigbee module.

Other communication technologies may also be used. For example, one of a cellular communication module, a third generation (3G) mobile communication module, a fourth generation (4G) mobile communication module, and a fourth generation long term evolution (LTE) mobile communication module may be included.

The controller 130 controls most operations of the first imaging apparatus 100.

The controller 130 controls the camera 110, acquires low image data, controls image processor 140 and displays a live view image on the display unit 150. The controller 130 may control the second imaging apparatus 200, perform photographing and acquire low image data. However, if the second imaging apparatus 200 includes a self image processing module, a finally generated image is received.

In particular, the controller 130 determines whether a field of view interference occurs between the first imaging apparatus 100 and the second imaging apparatus 200. The controller 130 may determine whether a field of view interference occurs based on information regarding a photographic condition of the second imaging apparatus 200 received through the communicator 135.

For example, if H>h in an equation below, the controller 130 may determine that a field of view interference occurs.

h=[D−(R+r)]tan(90−Θ/2)

H: a height of a lens of the second imaging apparatus

D: a distance between an optical axis of a lens of the imaging apparatus and an optical axis of a lens of the another imaging apparatus

R: a radius of a lens of the second imaging apparatus

r: a radius of a lens of the first imaging apparatus

Θ: a field of view of a lens of the first imaging apparatus

In response to tan(Θ/2)>(D−R)/H, the controller 130 may determine that a field of view interference occurs.

The first imaging apparatus 100 may autonomously store the parameter information in one of the SDRAM 160, the memory card 170 and the flash memory 180 so that the parameter information is managed. However, information regarding a height H of a lens of the second imaging apparatus 200 changes according to a zoom out/zoom in state of the lens 211 of the second imaging apparatus 200, and may be received from the second imaging apparatus 200. Meanwhile, if the second imaging apparatus 200 is a lens exchange type, a radius (R) of the lens changes, and thus, information regarding the radius (R) of the lens may be received from the second imaging apparatus.

The first imaging apparatus 100 may further include a distance sensor which determines a distance from an object in a field of view range of a lens of the first imaging apparatus 100. In this case, if a distance determined by the distance sensor is in a pre-determined range, the controller 130 may determine that a field of view interference occurs.

If it is determined that a field of view occurs , the controller 130 may change at least one photographic condition of the first imaging apparatus 100 and the second imaging apparatus 200.

As an exemplary embodiment, if a field of view interference occurs, the controller 130 may zoom out at least one lens of the first imaging apparatus 100 and the second photographing apparatus 200.

As an another exemplary embodiment, if the field of view interference occurs, the controller 130 may rotate at least one lens of the first imaging apparatus 100 and the second imaging apparatus 200.

As other exemplary embodiment, if the field of view interference occurs, the controller 130 may move at least one lens of the first imaging apparatus 100 and the second imaging apparatus 200.

A moving distance x of the lens 211 of the second imaging apparatus 200 may be calculated using an equation below.

x=(H−h)tan(Θ/2)

h=[D−(R+r)]tan(90−Θ/2)

H: a height of a lens of the another imaging apparatus

D: a distance between an optical axis of a lens of the imaging apparatus and an optical axis of a lens of the another imaging apparatus

R: a radius of a lens of the another imaging apparatus

r: a radius of a lens of the imaging apparatus

Θ: a field of view of a lens of the imaging apparatus

The controller 130 includes a hardware configuration such as a CPU and a cache memory, an operating system, and software of an application which performs a specific purpose. According to a system clock, a control command regarding each element of the first imaging apparatus 100 is read to a memory, and according to the control command which is read, an electronic signal is generated and each element of hardware is operated.

The USB module 190 provides an interface with an external apparatus. If the USB module 190 is connected to a personal computer (PC) or other external apparatuses, the USB module 190 processes a transmission and a reception of image data. Also, a firmware transmission and reception for upgrading the firmware is processed.

The SDRAM 160 is used for storing an image or an image operation by a CPU. In an exemplary embodiment, DDR SDRAM which outputs from both a rising edge and a descending edge of a system clock so that the output increases twice as much as an output from the rising edge only, may be used.

The flash memory 180 stores a firmware program, various adjustment information corresponding to a specification of the first imaging apparatus 100, setting information of the first imaging apparatus 100 by a user input, a photographed image file and the like.

The memory card 170 includes a flash memory, and is detachable from the first imaging apparatus 100. The memory card 170 may store a photographed image file.

The display unit 150 is configured to display at least one of an interface consisting of a character, an icon and the like, an object, an imaging apparatus information, a motion image and a still image. Also, the display unit 150 may perform an electronic viewfinder function which displays a live view as described above.

Here, a kind of an object is not limited. In other words, an object may be at least one of an application icon, a content icon, a thumbnail image, a folder icon, a widget, a list item, a menu and a content image, etc. If a corresponding image is selected, an application icon runs an application included in the first imaging apparatus 100. A content icon plays a content if a corresponding image is selected. A thumbnail image is an image reduced to a small size so that the image is viewable at a glance. A folder icon displays a file in a folder if a corresponding image is selected. A widget is an icon which provides a user interface to execute an application icon exactly without selecting various steps of menus. A list item is configured to display a file in a list shape, and a menu image is configured to display a selectable menu. In particular, the display unit 150 provides a user interface as described below.

The display unit 150 may be planned with various display panels. In other words, the display unit 150 may be realized as various display techniques such as an organic light emitting diodes (OLED), a liquid crystal display (LCD) panel, a plasma display panel (PDP), a vacuum fluorescent display (VFD), a field emission display (FED), an electro luminescence display (ELD) and the like. A display panel may consist of a luminescent type, but it does not exclude a reflection type display (E-ink, P-ink, photonic crystal). Also it may be realized as a flexible display, a transparent display and the like.

The inputter 125 is configured to receive a user input. The inputter 125 may include at least one button 126 as illustrated in FIGS. 1, 2 and 4. Also, the inputter 125 may include a touch screen which is located on a display unit 120.

The at least one button 126 may be formed as a push-type or a touch-type at a front side, a flank side or a back side of the first imaging apparatus 100 and may include at least one of a power/lock button, a shutter button, a menu button, a home button, a back button, and a search button. If a button 126 is pushed, a corresponding control command is generated and passed to the controller 130, and the controller 130 controls an operation of the first imaging apparatus according to a corresponding control command.

The first imaging apparatus 100 includes a power supplier and an interface for a connection with an external apparatus.

A configuration of the second imaging apparatus 200 is similar to the first imaging apparatus 100. Meanwhile, as described above, the second imaging apparatus 200 might not include at least one of a power supplier, a display unit, a SDRAM, a memory card and a flash card.

Hereinafter, a user interface where the display unit 150 of the first imaging apparatus 100 outputs is explained.

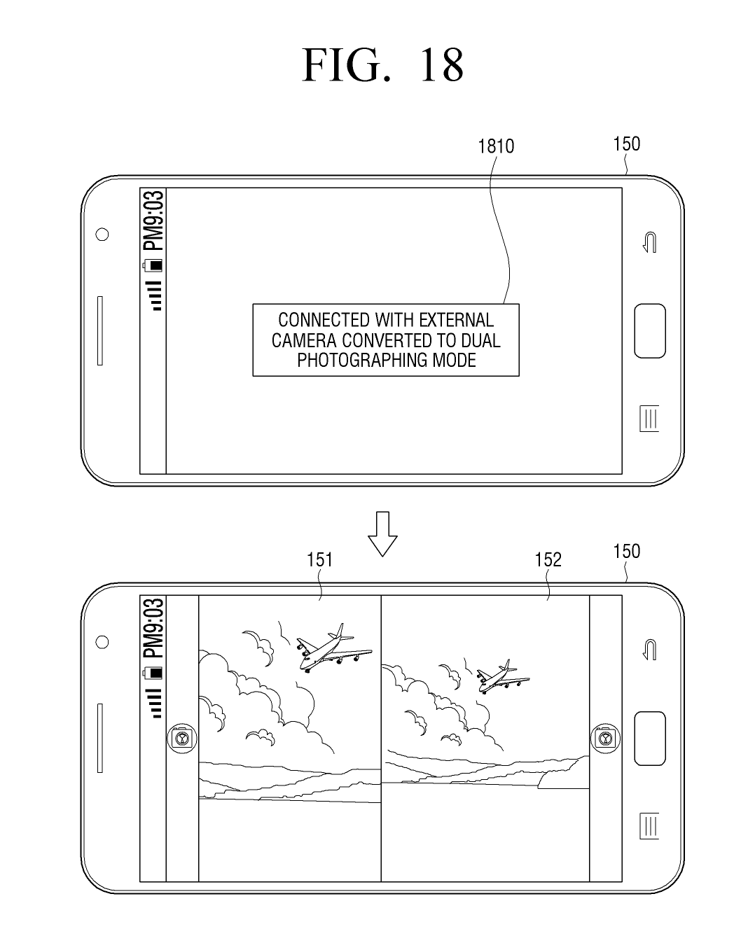

FIGS. 18 to 22 are views illustrating a user interface screen according to various exemplary embodiments.

If the first imaging apparatus 100 is connected with the second imaging apparatus 200, the controller 130 determines a connection with the second imaging apparatus 200 and controls the display unit 150 to output a message accordingly.

If the first imaging apparatus 100 is connected with the second imaging apparatus 200, an intention of a user is to photograph using a plurality of cameras, and thus, the controller 130 sets the first imaging apparatus 100 to a dual photographing mode which photographs a subject using a plurality of cameras. In this case, as illustrated in FIG. 18, a message 1810 which recites “an external camera is connected. Convert to a dual photographing mode” is displayed. After a pre-determined time, a live view image of the second imaging apparatus is displayed on the first area 151 of a display screen, and the display unit 150 is controlled to display a live view image of the first imaging apparatus in the another area 152.

If the first imaging apparatus 100 is connected to the second imaging apparatus 200 and a field of view interference occurs, the controller 130 may control the display unit 150 to output a message.

In other words, if a field of view occurs, a message which recites “a field of view occurs” is displayed and the display unit 150 is controlled to display menu items 1920-1950 for resolving the field of view interference as illustrated in FIG. 19. The menu items include removing an image where a field of view interference area occurs 1920, ignoring and photographing as it is 1930, lens controlling 1940, image interpolating of a field of view interference area 1950 and converting a mode 1960. A user may touch a menu item on a touch screen so that a desired menu item is selected.

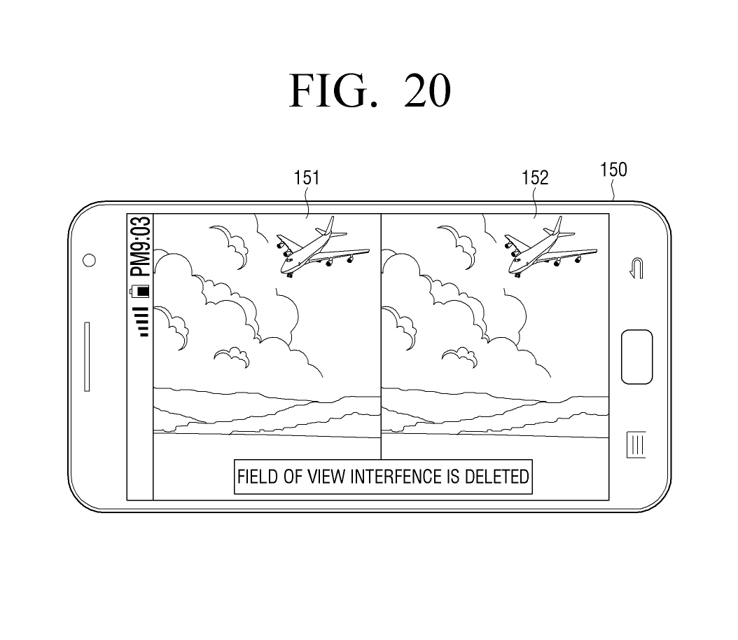

If the removing menu item 1920 is selected, a message which recites “a field of view interference is deleted” is displayed and after the field of view interference is cropped, an expanded image is displayed on the another area 152 of a display screen as illustrated in FIG. 20.

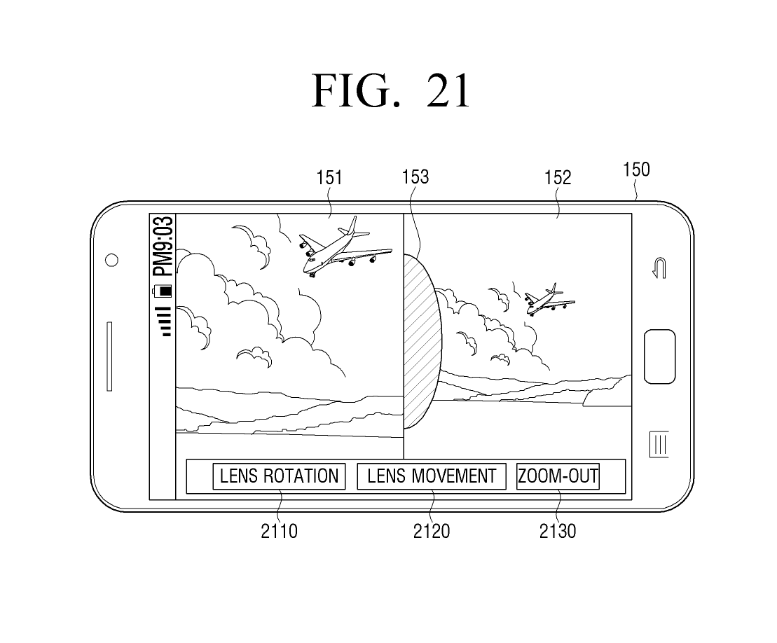

If a menu item of controlling lens 1940 is selected, the controller 130 controls the display unit 150 to display a submenu item as illustrated in FIG. 21. The submenu item includes a lens rotation 2110, a lens movement 2120 and a zoom-out. Meanwhile, according to a specification of the second imaging apparatus 200 which is connected, a composition of the menu may change. For example, if a function of a lens movement 2120 is not available, the lens movement 2120 menu might not be displayed.

If each of submenus is selected, the controller 130 controls the display unit 150 to generate a control command for controlling a lens and display an image generated by the controlled lens as described above.

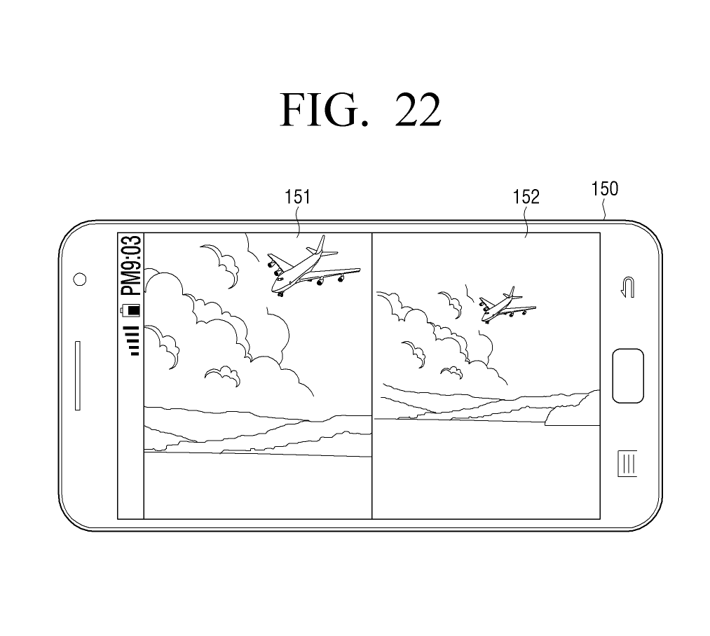

In FIG. 19, if a menu item of image interpolation 1950 of a field of view interference area is selected, the controller 130 controls the image processor 140 to interpolate a field of view interference area, and controls the display unit 150 to display a live view image of which the field of view interference area is interpolated as illustrated in FIG. 22.

In FIG. 19, in a case where a field of view interference exists, if a menu item of converting a mode is selected, the controller 130 converts a mode from a dual photographing mode to a single photographing mode which photographs a subject using a single camera.

Hereinafter, an imaging method according to various exemplary embodiments will be explained.

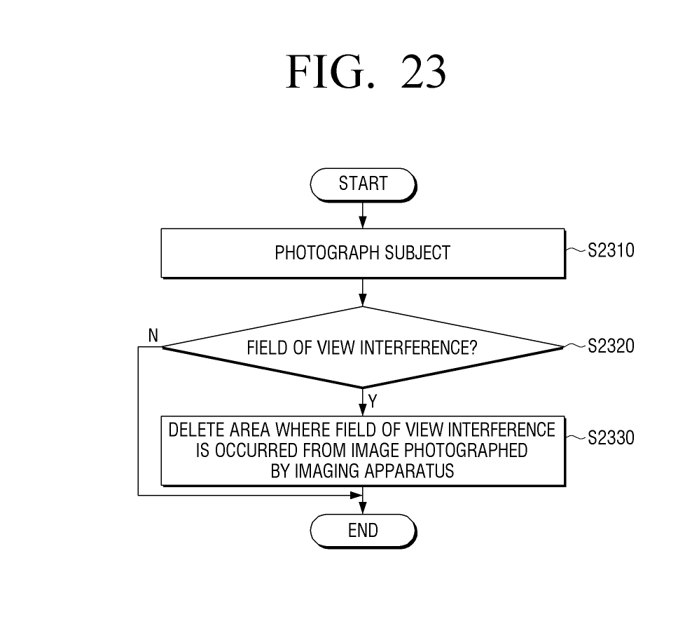

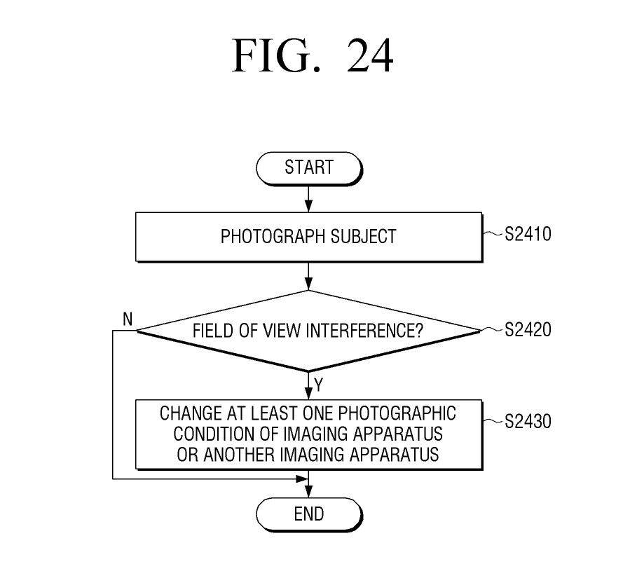

FIGS. 23-24 are flowcharts illustrating an imaging method according to various exemplary embodiments.

Referring to FIG. 23, an imaging method of an imaging apparatus according to an exemplary embodiment includes photographing a subject (S2310), and if a field of view interference occurs between the imaging apparatus and the another imaging apparatus connected to the imaging apparatus (S2320-Y), removing an area where the field of view interference occurs from an image photographed by the imaging apparatus (S2330).

At this moment, the removing an area where a field of view interference occurs includes determining that a field of view interference occurs if H>h in an equation below.

h=[D−(R+r)]tan(90−Θ/2)

H: a height of a lens of the another imaging apparatus

D: a distance between an optical axis of a lens of the imaging apparatus and an optical axis of a lens of the another imaging apparatus

R: a radius of a lens of the another imaging apparatus

r: a radius of a lens of the imaging apparatus

Θ: a field of view of a lens of the imaging apparatus

The removing an area where a field of view interference occurs may delete an area up to x value below from an edge of the photographed image.

x=(H−h)*Xp/H

The removing an area where a field of view interference occurs may determine that a field of view interference occurs in response to tan(Θ/2)>(D−R)/H.

The imaging method may determine that a field of view interference occurs if the determined distance is in a pre-determined range.

The imaging method may further include interpolating an image of an area where the field of view interference occurs using a photographed image of the another imaging apparatus.

Referring to FIG. 24, an imaging method of an imaging apparatus according to another exemplary embodiment may further include photographing a subject (S2410), and if a field of view interference occurs between the imaging apparatus and the another imaging apparatus connected to the imaging apparatus (S2420-Y), changing at least one photographic condition of the imaging apparatus and the another imaging apparatus (S2430).

If the field of view interference occurs, the changing a photographic condition may zoom out at least one lens of the imaging apparatus and the another imaging apparatus.

If the field of view interference occurs, at least one lens of the imaging apparatus and the another imaging apparatus may be rotated.

If the field of view interference occurs, the changing a photographic condition may move at least one lens of the imaging apparatus and the another imaging apparatus.

At this moment, a distance of which the another imaging apparatus moves may be calculated using an equation below.

x=(H−h)tan(Θ/2)

h=[D−(R+r)]tan(90−Θ/2)

H: a height of a lens of the another imaging apparatus

D: a distance between an optical axis of a lens of the imaging apparatus and an optical axis of a lens of the another imaging apparatus

R: a radius of a lens of the another imaging apparatus

r: a radius of a lens of the imaging apparatus

Θ: a field of view of a lens of the imaging apparatus

The imaging method described above may be stored as a program in a non-transitory computer readable medium. Specifically, a CD, a DVD, a hard disk, a Blu-ray disk, a USB, a memory card and ROM may be the non-transitory readable medium.

Also, the imaging method described above may be equipped with a hardware IC chip in a shape of embedded software such as a FPGA, and be provided, and also may be included as a partial configuration in the imaging apparatuses 100 and 200 described above.

Desirable exemplary embodiments of the present invention were illustrated and explained above, but the present invention is not limited to the described exemplary embodiments. Also, the description of the embodiments of the present invention is intended to be illustrative, and not to limit the scope of the claims, and it is appreciated by those skilled in the art that changes may be made to the embodiments without departing from the principles and spirit of the invention, the scope of which is defined in the appended claims.

What is claimed is:

1. An imaging apparatus, comprising:
a camera configured to capture a subject;
a combiner configured to connect the imaging apparatus with another imaging apparatus;
a controller configured to perform capturing by controlling the camera and the other imaging apparatus; and
an image processor configured to, in response to a field of view interference occurring between the camera and the other imaging apparatus, delete an area where the field of view interference occurs, from an image captured by the camera.

2. The imaging apparatus as claimed in claim 1, wherein the controller is configured to determine that the field of view interference occurs in response to H>h,
wherein:
h=[D−(R+r)]tan(90−Θ/2), and
wherein H is a height of a lens of the other imaging apparatus;
D is a distance between an optical axis of a lens of the imaging apparatus and an optical axis of the lens of the other imaging apparatus;
R is a radius of the lens of the other imaging apparatus;
r is a radius of the lens of the imaging apparatus; and
Θ is the field of view of the lens of the imaging apparatus.

3. The imaging apparatus as claimed in claim 1, wherein the controller is configured to determine that the field of view interference occurs in response to tan(Θ/2)>(D−R)/H, and
wherein H is a height of a lens of the other imaging apparatus;
D is a distance between an optical axis of a lens of the imaging apparatus and an optical axis of the lens of the other imaging apparatus;
R is a radius of the lens of the other imaging apparatus; and
Θ is the field of view of the lens of the imaging apparatus.

4. The imaging apparatus as claimed in claim 1 further comprising:
a distance sensor configured to determine a distance between the imaging apparatus and the subject in the field of view of a lens of the imaging apparatus, and
wherein the controller is configured to determine that the field of view interference occurs in response to the determined distance being in a pre-determined range.

5. The imaging apparatus as claimed in claim 2, wherein the image processor is configured to delete the area of the image where the field of view interference occurs, not less than x from an edge of the captured image, wherein x=(H−h)*Xp/H, and wherein Xp is a length of a horizontal axis of an image captured by the imaging apparatus.

6. The imaging apparatus as claimed in claim 1, wherein the image processor is configured to interpolate the area of the image where the field of view interference occurs using a captured image of the other imaging apparatus.

7. The imaging apparatus as claimed in claim 1, wherein the controller, in response to the field of view interference occurring, is configured to change a capturing condition of at least one from among the imaging apparatus and the other imaging apparatus.

8. The imaging apparatus as claimed in claim 7, wherein the controller, in response to the field of view interference occurring, is configured to zoom out at least one lens from among the imaging apparatus and the other imaging apparatus.

9. The imaging apparatus as claimed in claim 7, wherein the controller, in response to the field of view interference occurring, is configured to rotate at least one lens from among the imaging apparatus and the other imaging apparatus.

10. The imaging apparatus as claimed in claim 7, wherein the controller, in response to the field of view interference occurring, is configured to move at least one lens from among the imaging apparatus and the other imaging apparatus.

11. The imaging apparatus of claim 10, wherein x indicating a shortest distance where a lens of the other imaging apparatus moves is calculated using an equation below:
x=(H−h)tan(Θ/2); and
h=[D−(R+r)]tan(90−Θ/2), and
wherein H is a height of the lens of the other imaging apparatus;
D is a distance between an optical axis of a lens of the imaging apparatus and an optical axis of the lens of the other imaging apparatus;
R is a radius of the lens of the other imaging apparatus;
r is a radius of the lens of the imaging apparatus; and
Θ is the field of view of the lens of the imaging apparatus.

12. An imaging method of an imaging apparatus, the method comprising:
capturing a subject; and
in response to a field of view interference occurring between the imaging apparatus and another imaging apparatus which is connected to the imaging apparatus, deleting an area where the field of view interference occurs from an image captured by the imaging apparatus.

13. The method as claimed in claim 12, wherein the deleting the area where the field of view interference occurs comprises:
in response to H>h, determining that the field of view interference occurs, wherein:
h=[D−(R+r)]tan(90−Θ/2), and wherein
H is a height of a lens of the other imaging apparatus;
D is a distance between an optical axis of a lens of the imaging apparatus and an optical axis of the lens of the other imaging apparatus;
R is a radius of the lens of the other imaging apparatus;
r is a radius of the lens of the imaging apparatus; and
Θ is the field of view of the lens of the imaging apparatus.

14. The method as claimed in claim 13, wherein the deleting the area where the field of view interference occurs comprises:
deleting the area of the image where the field of view interference occurs, not less than x from an edge of the captured image, wherein x=(H−h)*Xp/H, and wherein Xp is a length of a horizontal axis of an image captured by the imaging apparatus.

15. The method as claimed in claim 12, wherein
in response to the field of view interference occurring between the imaging apparatus and the other imaging apparatus which is connected to the imaging apparatus, changing a capturing condition of at least one from among the imaging apparatus and the other imaging apparatus.

16. The method as claimed in claim 15, wherein the changing the capturing condition comprises:
in response to the field of view interference occurring, zooming out at least one lens from among the imaging apparatus and the other imaging apparatus.

17. The method as claimed in claim 15, wherein the changing the capturing condition comprises:
in response to the field of view interference occurring, rotating at least one lens from among the imaging apparatus and the other imaging apparatus.

18. The method as claimed in claim 15, wherein the changing the capturing condition comprises:
in response to the field of view interference occurring, moving at least one lens from among the imaging apparatus and the other imaging apparatus.

19. The method as claimed in claim 18, wherein x indicating a shortest distance where a lens of the other imaging apparatus moves is calculated using an equation below:
x=(H−h)tan(Θ/2); and
h=[D−(R+r)]tan(90−Θ/2), and wherein:
H is a height of a lens of the other imaging apparatus;
D is a distance between an optical axis of a lens of the imaging apparatus and an optical axis of the lens of the other imaging apparatus;
R is a radius of the lens of the other imaging apparatus;
r is a radius of the lens of the imaging apparatus; and
Θ is the field of view of the lens of the imaging apparatus.

20. A non-transitory recordable medium as claimed in claim 12, wherein the non-transitory recordable medium records a computer program for performing an imaging method.

21. An imaging apparatus comprising:
a controller;
a first camera comprising a first lens; and
a second camera comprising a second lens, wherein the controller is configured to determine whether a portion of the first lens of the first camera is in a field of view of the second camera, and in response to determining that the portion of the lens of the first camera is in the field of view of the second camera, adjust the first camera.

22. The imaging apparatus of claim 21, further comprising:
a first display screen and second display screen,
wherein the first display screen is configured to display an image corresponding to the first camera and the second display screen is configured to display an image corresponding to the second camera.

23. The imaging apparatus of claim 22, wherein in response to determining that the portion of the lens of the first camera is in the field of view of the second camera, the controller is further configured to control the first and the second display screens to display options to a user for adjusting the first camera.

24. The imaging apparatus of claim 23, wherein the options to the user include at least one from among deleting an area of the image where the portion of the lens of the first camera is in the field of view of the second camera, ignoring the area of the image where the portion of the lens of the first camera is in the field of view of the second camera, controlling the lens of the first camera so the first camera is not in the field of view of the second camera, interpolating the area of the image where the portion of the lens of the first camera is in the field of view of the second camera, and switching to a single capturing mode.
